(19) United States
(12) Patent Application Publication
(10) Pub. No.: US 2025/0292454 A1
(43) Pub. Date: Sep. 18, 2025

(54) METHOD FOR GENERATING A COLORED IMAGE, COMPUTER PROGRAM PRODUCT AND SYSTEM FOR GENERATING A COLORED IMAGE

(71) Applicant: Carl Zeiss AG, Oberkochen (DE)

(72) Inventors: Aaron Montag, Oberkochen (DE); Maria Shcherbina, Oberkochen (DE)

(21) Appl. No.: 19/080,852

(22) Filed: Mar. 15, 2025

(30) Foreign Application Priority Data
Mar. 15, 2024 (DE) 10 2024 107 516.3

(51) Int. Cl. G06T 11/00; G06T 5/20; G06T 5/50; H04N 23/11; H04N 23/84

(52) U.S. Cl. CPC G06T 11/001; G06T 5/20; G06T 5/50; H04N 23/11; H04N 23/84; G06T 2207/10024; G06T 2207/10048; G06T 2207/20084

(57) ABSTRACT

The invention relates to a method, a computer program product and a system for generating a colored image. The method comprises capturing a first image using a camera, wherein the first image contains a first set of first pixels, which are in color, and wherein the first image shows only an environment; capturing a second image using the camera, wherein the second image contains a second set of second pixels, which are not in color, and wherein the second image contains the environment, on the one hand, and an object arranged in the environment, on the other hand; inputting both a subset, concerning the environment, of the set of first pixels of the first image and a second subset, concerning the environment, of the set of second pixels of the second image into the processor unit as input variables; computing color information for a pixel of the second subset of the set of second pixels of the second image on the basis of a pixel of the subset of the set of first pixels of the first image; and generating the colored image that contains an object arranged in the environment on the basis of the second image and on the basis of the computed color information of the pixel of the second subset of the set of second pixels of the second image.

### CROSS-REFERENCE TO RELATED APPLICATION

This application claims the priority of the German patent application No. 10 2024 107 516.3, filed on Mar. 15, 2024, which is incorporated herein by reference.

The invention relates to a method for generating a colored image that contains an object arranged in an environment. By way of example, the object is an animal. Furthermore, the environment is for example the animal's natural environment, in particular a forest. The invention furthermore relates to a computer program product containing a program code that is able to be loaded into a processor unit of a system and that, when it is executed, controls the system such that a method according to the invention is carried out. The invention furthermore relates to a system for generating a colored image, wherein the system comprises a camera for capturing images and a processor unit containing a computer program product.

The prior art discloses a wildlife camera that has an objective lens, an infrared blocking filter arranged so as to be moveable and an optical sensor unit. The known wildlife camera is furthermore designed with at least one motion sensor. The known wildlife camera is used for example to record wild animals and/or in biological research to observe wild animals. When the motion sensor detects the presence of an animal, the wildlife camera is used to capture an image of the animal. More specifically, the objective lens is used to image an image of the animal onto the optical sensor unit. The image may be stored on a storage unit and/or be forwarded to a reception device over a wireless connection.

In order not to disturb the wild animals, the known wildlife camera does not use a normal flash of light. If brightness is sufficient, it is then also certainly possible to generate the image with sufficient quality. The image of the animal is then generally captured with the infrared blocking filter arranged in the beam path of the wildlife camera. The image of the animal thereby generated is a colored image. In other words, the image thereby generated is in color.

When brightness is no longer sufficient (for example at dusk or at night), the image of the animal is generally captured without the infrared blocking filter. Furthermore, the image of the animal is captured using a near-infrared light source that is arranged on the wildlife camera and radiates the near-infrared light that it generates onto the animal. The near-infrared light generally does not disturb the animal. However, the image of the animal thereby generated is then not a colored image, but rather an image that depicts the objects depicted in the image in grayscale levels (in extreme cases black or white). These grayscale levels mean that the objects depicted in the image do not appear to a viewer as they do in reality, since a color depiction is not present.

With regard to the prior art, reference is made by way of example to EP 3 631 761 B1, DE 10 2021 123 275 B3, WO 2022/089535 A1, CN 113298177 A, CN 111709903 A, CN 109949353 A, US 2018/0338092 A1, CN 105590305 A, U.S. Pat. No. 8,836,793 B1 and US 2020/167972 A1.

The invention is based on the object of providing a method, a computer program product and a system in which a colored image is generated based on an image containing grayscale levels.

According to the invention, this object is achieved by way of a method having the features of claim 1. A computer program product containing a program code that is able to be loaded into a processor unit of a system for generating a colored image and that, when it is executed, controls the system such that a method according to the invention is carried out is given by the features of claim 15. A system according to the invention for generating a colored image is given by the features of claim 16. Further features of the invention will become apparent from the following description, the appended claims and the appended drawings.

The method according to the invention is configured to generate a colored image, wherein the colored image contains an object arranged in an environment. By way of example, the object is an animal. Furthermore, the environment is for example the animal's natural environment, for example a forest. A camera is used to record the object. The camera has for example an objective lens, an infrared blocking filter arranged so as to be moveable and/or an optical sensor unit. In particular, the optical sensor unit is designed as a semiconductor element, for example as a CMOS. The camera furthermore has for example at least one motion sensor for detecting a movement. When a movement is detected, provision is in particular made to capture an image using the camera. The abovementioned camera is designed in particular as a wildlife camera and is used for example to record wild animals and/or in biological research to observe wild animals. When the motion sensor detects the presence of an animal, the wildlife camera is used to capture an image of the animal. More specifically, the objective lens is used to image an image of the animal onto the optical sensor unit. By way of example, the image may be stored on a storage unit and/or be forwarded to a reception device over a wireless connection.

In the method according to the invention, a first image is captured using the camera. The first image captured in the abovementioned method step contains a first set of first pixels, which are in color. In other words, the first image is a colored image composed of the first pixels. Provision is furthermore made for the first image to show only the environment. In other words, the image is captured at a time when the object is not located in the field of view of the camera. In this respect, the image does not show the object, but rather only the environment in the field of view of the camera. By way of example, the first image does not depict an animal, but rather only the animal's natural environment, for example a patch of forest located in the field of view of the objective lens of the camera.

By way of example, the first image is captured when there is sufficient natural brightness, in particular in daylight. The first image is accordingly captured for example without the use of a flash of light. Provision is in particular made to capture the first image with the infrared blocking filter arranged in the beam path of the camera. The captured first image is a colored image. In other words, the captured first image is in color.

In a further method step of the method according to the invention, a second image is captured using the camera, wherein the second image contains the environment, on the one hand, and an object arranged in the environment, on the other hand. By way of example, the object is an animal or comprises multiple animals. The second image contains a second set of second pixels, which are not in color. In other words, the second image captured in this method step is not a colored image, but rather an image that depicts the environment, on the one hand, and the object arranged in the environment, on the other hand, in grayscale levels (in extreme cases black or white).

By way of example, the second image is captured without the infrared blocking filter and using a near-infrared light source that is arranged on the camera and radiates the near-infrared light that it generates onto the object and the environment located in the field of view of the camera. By way of example, the near-infrared light generally does not disturb an animal.

The second image is captured in particular at a time when natural brightness is not sufficient to capture the second image so as to be able to recognize contours and details of the environment and/or of the object in the second image (for example at dusk or at night). However, as explained above, the second image is not a colored image, but rather an image that depicts the object depicted in the second image and its environment in grayscale levels (in extreme cases black or white).

In yet a further method step of the method according to the invention, a first subset of the set of second pixels of the second image is determined using a processor unit, wherein the first subset of the set of second pixels depicts the object. In other words, this method step comprises identifying those pixels from the set of the second pixels that contain only the object (and not the environment) in the second image. These pixels then form the first subset of the set of second pixels. A second subset of the set of second pixels of the second image is also determined using the processor unit, wherein the second subset of the set of second pixels depicts the environment. In other words, this method step comprises identifying those pixels from the set of the second pixels that contain only the environment (and not the object) in the second image.

The abovementioned processor unit is for example a processor unit of the system according to the invention, which will be explained in more detail below. By way of example, the processor unit is formed in one part or in multiple parts. It may in particular be arranged at a different location than the abovementioned camera. In other words, the processor unit and the abovementioned camera are physically separate from one another. In particular, the distance between the processor unit and the abovementioned camera may be more than 5 km, more than 10 km or more than 50 km. A data connection between the processor unit and the camera is provided for example by a wireless connection, in particular a radio connection or a mobile radio connection.

In yet a further method step of the method according to the invention, a subset of the set of first pixels of the first image is determined using the processor unit. In other words, a few pixels are determined from the set of the first pixels of the first image and form the abovementioned subset. Accordingly, the abovementioned subset comprises a smaller number of pixels than the set of the first pixels of the first image. The abovementioned subset comprises only pixels of the first image that correspond to corresponding pixels of the set of second pixels of the second image, wherein the corresponding pixels of the set of second pixels of the second image contain only the environment. In other words, the determined subset of the set of first pixels of the first image comprises only pixels that show the environment. The abovementioned subset does not comprise pixels at whose position in the second image the object is depicted. The subset of the set of first pixels of the first image may be determined in any way, and so it is possible to use any determination technique suitable for the invention. Provision is made in particular for the pixels of the abovementioned subset to be determined using a random generator. In addition or as an alternative thereto, provision is made for the pixels of the abovementioned subset to be distributed uniformly or non-uniformly in the first image.

In a further method step of the method according to the invention, both the subset of the set of first pixels of the first image and the second subset of the set of second pixels of the second image are input into the processor unit as input variables. Then, using the processor unit, color information is computed for at least one pixel of the second subset of the set of second pixels of the second image on the basis of at least one pixel of the subset of the set of first pixels of the first image. In other words, both the subset of the set of first pixels of the first image and the second subset of the set of second pixels of the second image are input into the processor unit as input variables. The processor unit then computes at least one output variable, namely color information for at least one pixel of the second subset of the set of second pixels of the second image on the basis of at least one pixel of the subset of the set of first pixels of the first image. The pixel of the second subset of the set of second pixels of the second image thus receives color information, even though this pixel originally comprises only information with regard to a grayscale level.

In yet a further method step of the method according to the invention, the colored image of the object arranged in the environment is generated on the basis of the second image and on the basis of the color information of the at least one pixel of the second subset of the set of second pixels of the second image using the processor unit. In other words, the colored image is generated by way of the processor unit based on the second image, which is not in color, on the one hand, and on the computed color information of the at least one pixel of the second subset of the set of second pixels of the second image, on the other hand, said colored image depicting the environment, on the one hand, and the object arranged in the environment, on the other hand. By virtue of the method according to the invention, the environment in the generated colored image is depicted in color.

The method according to the invention accordingly ensures that a colored image is generated based on an image containing grayscale levels. In contrast to the known prior art, a subset of the set of first pixels of the first image is used here, wherein the pixels of this subset contain color information. This color information is used to compute color information for at least one pixel of the second, non-colored image in order ultimately to generate a colored image that contains a colored environment and an object arranged in the environment.

The method according to the invention will be explained again below in other words. In the method according to the invention, a first image containing first pixels is first captured at a first time using the camera, wherein the first image shows only an environment. An object of interest is not captured as well when the first image is captured. The first image is a colored image. Furthermore, in the method according to the invention, a second image containing second pixels is captured at a second time, different from the first time, using the camera, wherein the second image contains both the environment and an object that is of interest. By way of example, the object is an animal. The second image is not a colored image, but rather an image containing grayscale levels (in extreme cases black or white). Furthermore, provision is made in the method according to the invention to determine some of the pixels of the first image. These pixels each comprise color information. These pixels are also input into the processor unit as a first input variable. Those pixels of the second image that do not depict the object are furthermore input into the processor unit as a second input variable. The processor unit is then used to compute color information for at least one of the pixels of the second image, preferably for several of the pixels of the second image, or preferably for each pixel of the second image on the basis of the first input variable (that is to say on the basis of the determined pixels of the first image comprising the color information), wherein the abovementioned pixels of the second image are only those pixels of the second image that concern only the environment (and not the object). Subsequently, a colored image that contains the environment, on the one hand, and the object arranged in the environment, on the other hand, is generated by way of the processor unit on the basis of the second image and on the basis of the computed color information for the at least one pixel of the second image, for the multiple pixels of the second image or for each pixel of the second image, wherein these pixels concern only the environment (and not the object). The environment is thus depicted in color in the second image.

In one embodiment of the method according to the invention, provision is made, in addition or as an alternative, for the first image to be captured at a first time using the camera and for the second image to be captured at a second time, different from the first time, using the camera. By way of example, the first time is at a time of day when the first image is able to be captured with natural brightness sufficient to be able to sufficiently recognize contours and details in the first image. By way of example, the first time is at a time of day when it is bright and the sun is generally shining. Furthermore, for example, the second time is at a time of day when it is not bright, in particular at night. By way of example, the first time and the second time may be of the order of hours or days apart.

In a further embodiment of the method according to the invention, provision is made, in addition or as an alternative, for the first image to be captured using the camera such that each pixel of the first set of first pixels comprises color information and location information with regard to its position in the first image. In addition or as an alternative thereto, provision is made for the second image to be captured using the camera such that each pixel of the second set of second pixels comprises grayscale information and location information with regard to its position in the second image.

In yet a further embodiment of the method according to the invention, provision is made, in addition or as an alternative, for the color information to be computed, as explained above, such that color information is computed for each pixel of the second subset of the set of second pixels of the second image using the processor unit. In other words, both the subset of the set of first pixels of the first image and the second subset of the set of second pixels of the second image are input into the processor unit as input variables. The processor unit then computes output variables, namely respective color information for each pixel of the second subset of the set of second pixels of the second image on the basis of at least one pixel, multiple pixels or all pixels of the subset of the set of first pixels of the first image. Each pixel of the second subset of the set of second pixels of the second image thus receives color information, even though this pixel originally comprises only information with regard to a grayscale level (in extreme cases black or white).

In yet a further embodiment of the method according to the invention, provision is made, in addition or as an alternative, for the color information for the at least one pixel of the second subset of the set of second pixels of the second image to be computed on the basis of the subset of the set of first pixels of the first image. In other words, the abovementioned computing, explained above, is carried out on the basis of the entire subset of the set of first pixels of the first image. In this respect, all pixels that have been determined and assigned to the subset of the set of first pixels of the first image are used in the computing.

In one embodiment of the method according to the invention, provision is made, in addition or as an alternative, for the abovementioned computing to be carried out using (i) a mathematical model, (ii) machine learning and/or (iii) an artificial neural network. In other words, for example, an artificial intelligence computes a very specific output variable, explained above or below, or multiple very specific output variables, explained above or below, on the basis of the predefined input variables, explained above or below. Using these one or more output variables, it is possible to generate the colored image. In addition or as an alternative thereto, provision is made for the abovementioned computing to be carried out using (i) a single mathematical model and/or (ii) a single artificial neural network. In other words, the processor unit uses only a single mathematical model and/or only a single artificial neural network to compute the color information.

In a further embodiment of the method according to the invention, provision is made, in addition or as an alternative, also to depict the object in color in the image to be generated. For this purpose, provision is made, in this embodiment of the method according to the invention, for color information with regard to the object for the first subset of the set of second pixels of the second image to be loaded into the processor unit from a storage unit. As explained above or below, the first subset of the set of second pixels of the second image comprises the object. Furthermore, in this embodiment of the method according to the invention, color information is computed for at least one pixel of the first subset of the set of second pixels of the second image on the basis of the loaded color information using the processor unit. In other words, at least one pixel of the abovementioned first subset is assigned color information so that the object is able to be depicted in color. Preferably, color information is computed for several of the pixels or for each of the pixels of the first subset of the set of second pixels of the second image on the basis of the loaded color information using the processor unit. By way of example, the color information is computed such that both the pixels of the first subset of the set of second pixels of the second image and the loaded color information are input into the processor unit as input variables. The processor unit then computes output variables, namely respective color information for at least (a) one pixel or (b) for multiple pixels or (c) for each pixel of the first subset of the set of second pixels of the second image on the basis of the loaded color information. A pixel of the first subset of the set of second pixels of the second image thus receives color information, even though this pixel originally comprises only information with regard to a grayscale level. By way of example, provision is made, in addition or as an alternative, for the abovementioned computing to be carried out using (i) a mathematical model, (ii) machine learning and/or (iii) an artificial neural network. In other words, for example, an artificial intelligence computes a very specific output variable, explained above or below, or multiple very specific output variables, explained above or below, on the basis of the predefined input variables, explained above or below. Using these one or more output variables, it is possible to generate the colored image. In addition or as an alternative thereto, provision is made for the abovementioned computing to be carried out using (i) a single mathematical model and/or (ii) a single artificial neural network. In other words, the processor unit uses only a single mathematical model and/or only a single artificial neural network to compute the color information. In particular, provision is made, in this embodiment of the method according to the invention, for the colored image, which contains the environment, on the one hand, and the object arranged in the environment, on the other hand, to be generated using the computed color information for the at least one pixel of the first subset of the set of second pixels of the second image. Preferably, the colored image is generated using the computed color information for the multiple pixels or for each of the pixels of the first subset of the set of second pixels of the second image. The object is then depicted in color in the generated colored image.

As already explained above, in yet a further embodiment of the method according to the invention, provision is made, in addition or as an alternative, for the computing to be carried out on the basis of the loaded color information using the processor unit such that color information is computed for each pixel of the first subset of the set of second pixels of the second image. The colored image, which contains the environment, on the one hand, and the object arranged in the environment, on the other hand, is generated using the color information for each pixel of the first subset of the set of second pixels of the second image.

In yet a further embodiment of the method according to the invention, provision is made, in addition or as an alternative, for the generated colored image to be displayed on a display unit. By way of example, the display unit is a screen of a mobile communication unit, in particular of a portable telephone and/or of a tablet computer.

In one embodiment of the method according to the invention, provision is made, in addition or as an alternative, for the capturing of the first image using the camera to comprise not only capturing a single first image, but rather capturing multiple first images. Each image of the multiple first images shows only the environment of the object, and therefore not the object itself. In other words, each of the multiple first images is captured at times when the object is not located in the field of view of the camera. In this respect, each image of the multiple first images does not show the object, but rather only the environment in the field of view of the camera. By way of example, each of the multiple first images does not depict an animal, but rather only the animal's natural environment, for example a patch of forest located in the field of view of the objective lens of the camera. By way of example, the multiple first images are captured when there is sufficient natural brightness. Reference is made to the explanations given above, which also apply here. Furthermore, in this embodiment of the method according to the invention, one image of the captured multiple first images is determined using the processor unit. This determined image is then used for the method according to the invention. In particular, the subset of the set of first pixels is determined such that a subset of the set of first pixels of the determined image of the multiple first images is determined. By way of example, in this embodiment of the method according to the invention, provision is made for the image of the multiple first images to be selected by a user or by the processor unit. In particular, the image of the multiple first images that has the best contrast is selected. As an alternative, provision is made for example to combine two or more images of the multiple first images with one another using the processor unit such that in particular disturbances (for example shading, stray light or objects of no interest) are no longer visible or are barely still visible in the combined image. Provision is made in particular for the image of the multiple first images to be determined such that the image is computed on the basis of the multiple first images using the processor unit.

The camera mentioned above and below is generally designed to be stationary. The first image and the second image are therefore generally captured with the same field of view of the camera. However, due to external circumstances, it may be the case that the camera moves slightly between a first time when the first image is captured and a second time when the second image is captured, such that the field of view of the camera is slightly different at the first time and at the second time. In order to take this effect into account, in a further embodiment of the method according to the invention, provision is made for the captured first image and the captured second image to be aligned with one another. In other words, each pixel of the first set of first pixels of the first image is assigned exactly one corresponding pixel of the second set of second pixels of the second image using the processor unit. In yet other words, following the assignment, each pixel of the first image corresponds to a corresponding pixel of the second image. By way of example, provision is made to ascertain a transformation function @, such that the first pixels of the first image correspond to the second pixels of the second image (that is to say the first pixels of the first image match the second pixels of the second image). This is done for example by minimizing the following mathematical expression:

$${\sum }_{l ∈ \{ x , y \}} {‖ \vert {∇}_{l} Image 1 \vert - \vert {∇}_{l} Image 2 ( Φ ) \vert ‖}^{2} = {\sum }_{l ∈ \{ x , y \}} {‖ \vert {∇}_{l} Image 1 \vert ‖}^{2} - 2 \vert {∇}_{l} Image 1 \vert , \vert {∇}_{l} Image 2 ( Φ ) \vert + {‖ \vert {∇}_{l} Image 2 ( Φ ) \vert ‖}^{2}$$

where
Image1 and Image2 are each a monochromatic pixel image with the same resolution;
Image2(ϕ) denotes a pixel image with the same resolution, which was created by a local transformation ϕ of Image2;
∇x and ∇y are pixel-by-pixel directional derivatives of a monochromatic image;
   |∇ₗImage| is the respective pixel-by-pixel absolute value of a directional derivative;
∥A∥² denotes the sum of all squared pixel values of an image A; and
[symbol] A, B [symbol] is the vector scalar product of two images A and B considered as vectors.

Minimizing the above expression is equivalent to maximizing the expression [symbol] |∇ₗImage1|, |∇ₗImage2(ϕ)| [symbol] , that is to say the correlation of the two absolute gradients. In other words, Image2 is shifted such that its absolute gradients match those of Image1 as far as possible.

It may be the case that some details of the environment depicted in the second image are not particularly clearly visible. This is due for example to the fact that the second image is captured when there is not sufficient brightness, in particular at night. In order to counteract this effect, in yet a further embodiment of the method according to the invention, provision is made, in addition or as an alternative, for the second image to be processed before the second subset of the set of second pixels of the second image is input into the processor unit as an input variable. If for example a pixel of the subset of the set of second pixels of the second image does not satisfy a predefinable quality criterion, this pixel is selected using the processor unit. The selected pixel is then blended with a corresponding pixel of the first set of first pixels of the first image using the processor unit. In other words, the selected pixel of the second subset of the set of second pixels of the second image (that is to say a pixel that concerns only the environment) is enriched with information about the brightness of a pixel, corresponding to the selected pixel, of the first set of first pixels of the first image (wherein the corresponding pixel likewise concerns only the environment). By way of example, the blending is carried out by replacement. In other words, in the second image, a pixel that concerns only the environment is replaced by a pixel, corresponding to this pixel, of the first image (wherein the corresponding pixel likewise concerns only the environment) if the pixel in the second image does not satisfy the predefinable quality criterion. As an alternative thereto, provision is made for example for the blending to be produced by alpha blending. In alpha blending, the selected pixel of the second subset of the set of second pixels of the second image is assigned mixed information on the basis of the brightness of the selected pixel and of the pixel, corresponding to the selected pixel, of the first set of first pixels of the first image. By way of example, the predefinable quality criterion or a weighting of the alpha blending depends on the contrast.

In yet a further embodiment of the method according to the invention, provision is made, in addition or as an alternative, for the first image to be stored in an image storage unit after the first image has been captured using the camera. To determine the subset of the set of first pixels of the first image, the first image is loaded from the image storage unit into the processor unit. By way of example, the image storage unit is formed in one part or in multiple parts. It may in particular be arranged at a different location than the abovementioned camera. In other words, the image storage unit and the abovementioned camera are physically separate from one another. In particular, the distance between the processor unit and the abovementioned camera may be more than 5 km, more than 10 km or more than 50 km. The camera, the image storage unit and/or the processor unit are connected to one another, for example wirelessly. With regard to possible wireless connections, reference is made to the explanations above, which also apply here.

In one embodiment of the method according to the invention, provision is made, in addition or as an alternative, for the camera to have multiple camera units. By way of example, the camera has a first camera unit and a second camera unit. However, the invention is not limited to two camera units. On the contrary, any number of camera units suitable for the invention may be used. Each camera unit has its own objective lens. By way of example, the camera units are arranged with respect to one another such that the axes of the objective lenses of the camera units are oriented parallel to one another. In this embodiment of the method according to the invention, the first image is captured using the first camera unit. As already mentioned above, the first image contains the first set of first pixels, which are in color. By way of example, the first image is captured when there is sufficient natural brightness, in particular in daylight. The first image is accordingly captured for example without the use of a flash of light. The captured first image is a colored image. In other words, the captured first image is in color. The second image is captured, in this embodiment of the method according to the invention, using the second camera unit, wherein the second image contains the environment, on the one hand, and an object arranged in the environment, on the other hand. By way of example, the object is an animal or comprises multiple animals. As already mentioned above, the second image contains the second set of second pixels, which are not in color. In other words, the second image captured in this method step is not a colored image, but rather an image that depicts the environment, on the one hand, and the object arranged in the environment, on the other hand, in grayscale levels (in extreme cases black or white). By way of example, the second image is captured using a near-infrared light source that is arranged on the camera and radiates the near-infrared light that it generates onto the object and the environment located in the field of view of the second camera unit. By way of example, the near-infrared light generally does not disturb an animal. The second image is captured in particular at a time when natural brightness is not sufficient to capture the second image so as to be able to recognize contours and details of the environment and/or of the object in the second image (for example at dusk or at night). However, as explained above, the second image is not a colored image, but rather an image that depicts the object depicted in the second image and its environment in grayscale levels (in extreme cases black or white).

In a further embodiment of the method according to the invention, provision is made, in addition or as an alternative, for the first set of the first pixels of the first image to be scaled to the second set of the second pixels of the second image, for example using the processor unit. In addition or as an alternative thereto, provision is made for the second set of the second pixels of the second image to be scaled to the first set of the first pixels of the first image, for example using the processor unit.

All of the embodiments above and below of the method according to the invention are not restricted to the mentioned sequence of the method steps. The invention also comprises different sequences of the method steps that are suitable for solving the problem within the meaning of the invention. As an alternative or in addition, in the method according to the invention, provision is also made to carry out at least two method steps in parallel. Moreover, the embodiments above and below of the method according to the invention are not restricted to the complete scope of all of the method steps mentioned above or below. In particular, provision is made for individual or a plurality of the method steps above or below to be omitted in further embodiments.

The invention also relates to a computer program product containing a program code that is able to be loaded or is loaded into a processor unit of a system for generating a colored image that contains an object arranged in an environment, wherein the program code, when it is executed in the processor unit, controls the system such that a method having at least one of the features above or below or having a combination of at least two of the features above or below is performed. In other words, the invention also relates to a non-volatile computer-readable medium containing software that is able to be loaded or is loaded into a processor unit of a system for generating a colored image that contains an object arranged in an environment, wherein the software, when it is executed in the processor unit, controls the system such that a method having at least one of the features above or below or having a combination of at least two of the features above or below is performed. The software comprises executable code for performing at least one method step.

In this respect, the invention also relates to a processor unit that is assigned to a system for generating a colored image that contains an object arranged in an environment and is configured to carry out a method having at least one of the features above or below or having a combination of at least two of the features above or below.

The invention also relates to a system for generating a colored image that contains an object arranged in an environment. The system according to the invention is provided with a camera for capturing images. The system according to the invention furthermore has a processor unit into which a computer program product having at least one of the features above or below or having a combination of at least two of the features above or below is loaded.

In one embodiment of the system according to the invention, provision is made, in addition or as an alternative, for the system to have at least one storage unit and/or at least one display unit. The storage unit is designed in particular to store the captured first image and/or to store the color information about the object to be imaged. By way of example, the display unit is a screen of a mobile communication unit, in particular of a portable telephone and/or of a tablet computer.

In a further embodiment of the system according to the invention, provision is made, in addition or as an alternative, for the camera and/or the processor unit and/or the storage unit and/or the display unit to be physically separate from one another. In particular, the distance between the abovementioned units may be more than 5 km, more than 10 km or more than 50 km. A data connection between the abovementioned units and/or the camera is provided for example by a wireless connection, in particular a radio connection or a mobile radio connection.

The camera of the system according to the invention has for example an objective lens, an infrared blocking filter arranged so as to be moveable and/or an optical sensor unit. In particular, the optical sensor unit is designed as a semiconductor element, for example as a CMOS. The camera furthermore has for example at least one motion sensor for detecting a movement. When a movement is detected, provision is in particular made to capture an image using the camera. The abovementioned camera is designed in particular as a wildlife camera and is used for example to record wild animals and/or in biological research to observe wild animals. When the motion sensor detects the presence of an animal, the wildlife camera is used to capture an image of the animal. More specifically, the objective lens is used to image an image of the animal onto the optical sensor unit. By way of example, the image may be stored on the storage unit and/or be forwarded to a reception device over a wireless connection.

In a further embodiment of the system according to the invention, provision is made, in addition or as an alternative, for the camera to have multiple camera units. By way of example, the camera has a first camera unit for capturing the first image and a second camera unit for capturing the second image. However, the invention is not limited to two camera units. On the contrary, any number of camera units suitable for the invention may be used. Each camera unit has its own objective lens. By way of example, the camera units are arranged with respect to one another such that the axes of the objective lenses of the camera units are oriented parallel to one another.

The use of the system according to the invention is explained briefly below. A first image containing first pixels is first captured at a first time using the camera, wherein the first image shows only an environment. An object of interest is not captured as well when the first image is captured. The first image is a colored image. By way of example, the first image is stored in the storage unit of the system. Furthermore, a second image containing second pixels is captured at a second time, different from the first time, using the camera, wherein the second image contains both the environment and an object that is of interest. By way of example, the object is an animal. The second image is not a colored image, but rather an image containing grayscale levels (in extreme cases black or white). Furthermore, some of the pixels of the first image are determined using the processor unit. For this purpose, by way of example, the first image is loaded from the storage unit into the processor unit. The determined pixels of the first image each comprise color information. These determined pixels are input into the processor unit as a first input variable. Those pixels of the second image that depict only the environment and not the object are furthermore input into the processor unit as a second input variable. The processor unit is then used to compute color information for at least one of the pixels of the second image, preferably for several of the pixels of the second image, or preferably for each pixel of the second image on the basis of the first input variable (that is to say on the basis of the determined pixels of the first image comprising the color information), wherein the abovementioned pixels of the second image concern only the environment (and not the object). Subsequently, a colored image that contains the environment, on the one hand, and the object arranged in the environment, on the other hand, is generated by way of the processor unit on the basis of the second image and on the basis of the computed color information for the at least one pixel of the second image, for the multiple pixels of the second image or for each pixel of the second image, wherein the abovementioned pixels of the second image concern only the environment (and not the object). The environment is thus depicted in color in the second image.

By way of example, in the system according to the invention, the first image is captured using the first camera unit. As already mentioned above, the first image contains the first set of first pixels, which are in color. By way of example, the first image is captured when there is sufficient natural brightness, in particular in daylight. The first image is accordingly captured for example without the use of a flash of light. The captured first image is a colored image. In other words, the captured first image is in color. The second image is captured, in the system according to the invention, for example using the second camera unit, wherein the second image contains the environment, on the one hand, and an object arranged in the environment, on the other hand. By way of example, the object is an animal or comprises multiple animals. As already mentioned above, the second image contains the second set of second pixels, which are not in color. In other words, the captured second image is not a colored image, but rather an image that depicts the environment, on the one hand, and the object arranged in the environment, on the other hand, in grayscale levels (in extreme cases black or white). By way of example, the second image is captured using the near-infrared light source that is arranged on the camera and radiates the near-infrared light that it generates onto the object and the environment located in the field of view of the second camera unit. By way of example, the near-infrared light generally does not disturb an animal. The second image is captured in particular at a time when natural brightness is not sufficient to capture the second image so as to be able to recognize contours and details of the environment and/or of the object in the second image (for example at dusk or at night). However, as explained above, the second image is not a colored image, but rather an image that depicts the object depicted in the second image and its environment in grayscale levels (in extreme cases black or white).

In a further embodiment of the system according to the invention, provision is made, in addition or as an alternative, for the first set of the first pixels of the first image to be scaled to the second set of the second pixels of the second image, for example using the processor unit. In addition or as an alternative thereto, provision is made for the second set of the second pixels of the second image to be scaled to the first set of the first pixels of the first image, for example using the processor unit.

Further practical embodiments and advantages of the invention are described below in conjunction with the drawings, in which:

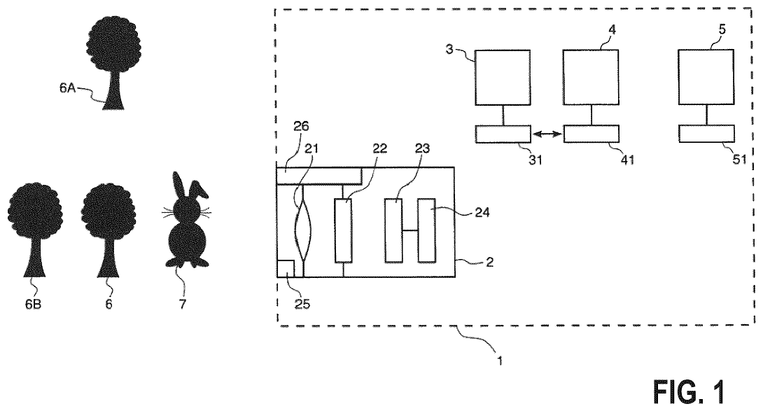

FIG. 1 shows a schematic illustration of a system according to the invention;

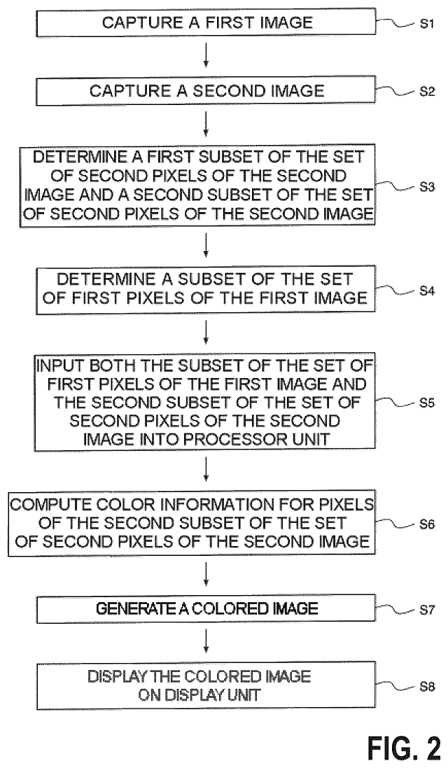

FIG. 2 shows a flowchart of a first embodiment of the method according to the invention;

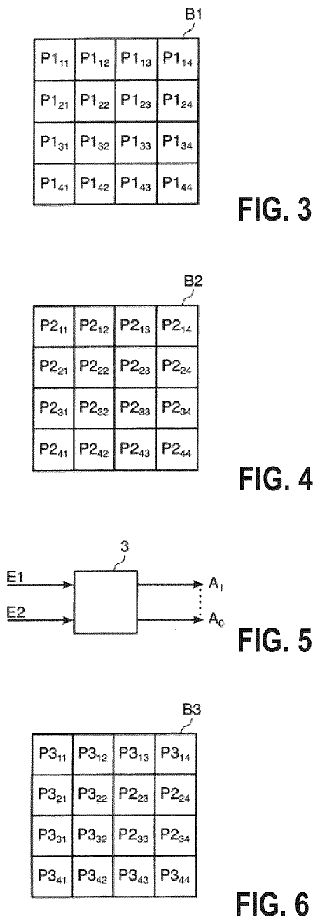

FIG. 3 shows a schematic illustration of a first image;

FIG. 4 shows a schematic illustration of a second image;

FIG. 5 shows a schematic illustration of a processor unit of the system according to the invention;

FIG. 6 shows a schematic illustration of a generated colored image;

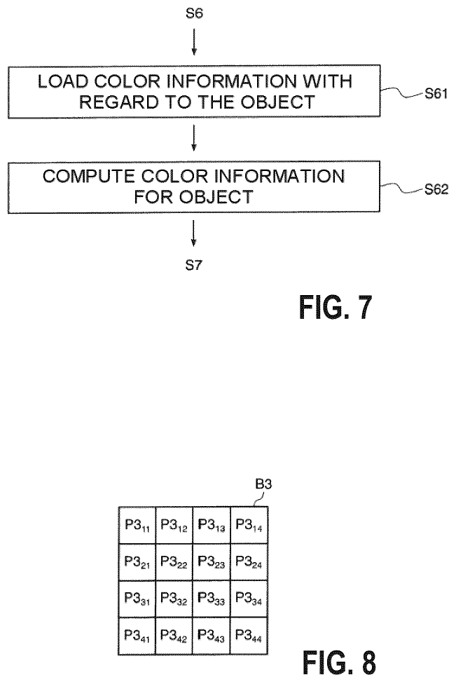

FIG. 7 shows a flowchart of a second embodiment of the method according to the invention;

FIG. 8 shows a schematic illustration of a further generated colored image;

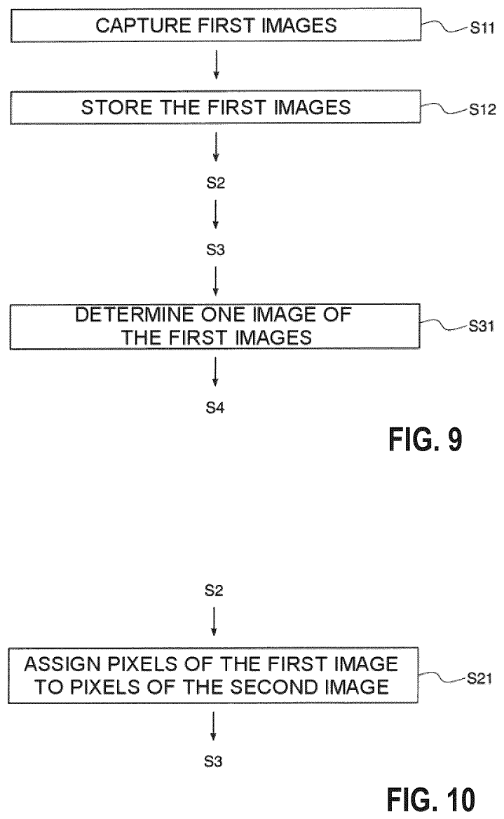

FIG. 9 shows a flowchart of a third embodiment of the method according to the invention;

FIG. 10 shows a flowchart of a fourth embodiment of the method according to the invention;

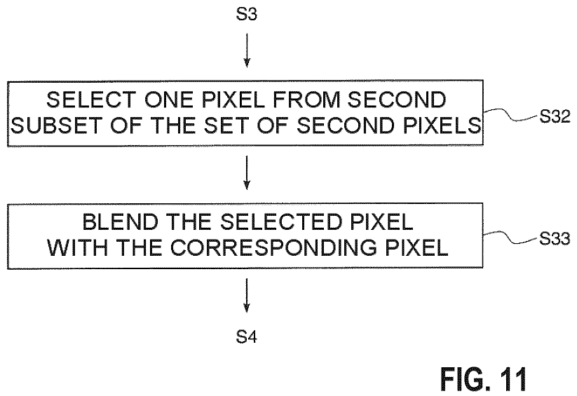

FIG. 11 shows a flowchart of a fifth embodiment of the method according to the invention; and

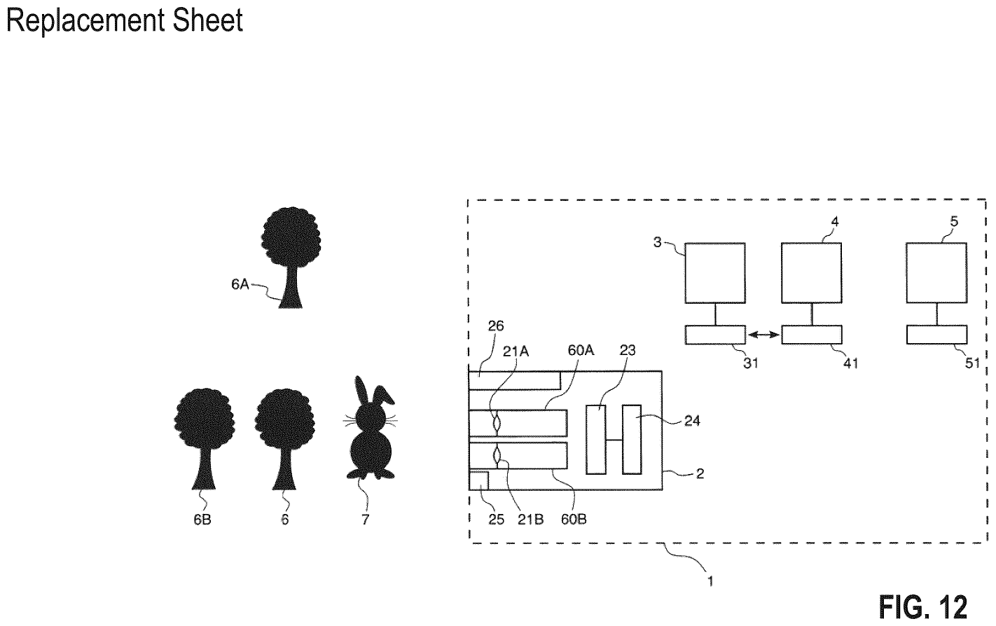

FIG. 12 shows a schematic illustration of a further system according to the invention.

FIG. 1 shows one embodiment of a system 1 according to the invention for generating a colored image that contains an object 7 arranged in an environment 6, 6A and 6B. The system 1 according to the invention is provided with a camera 2 for capturing images. The system 1 according to the invention furthermore comprises a processor unit 3, a storage unit 4 and a display unit 5. In the embodiment illustrated in FIG. 1 of the system 1 according to the invention, the camera 2, the processor unit 3, the storage unit 4 and the display unit 5 are physically separate from one another. In particular, the distance between the camera 2, the processor unit 3, the storage unit 4 and/or the display unit 5 may be more than 5 km, more than 10 km or more than 50 km. A data connection between the camera 2, the processor unit 3, the storage unit 4 and/or the display unit 5 is provided for example by a wireless connection, in particular a radio connection or a mobile radio connection. This will be discussed in more detail below. As an alternative thereto, in one embodiment of the system 1 according to the invention, provision is made for the camera 2, the processor unit 3, the storage unit 4 and/or the display unit 5 not to be physically separate from one another, and to be arranged for example in an identical device, in particular in a camera housing of the camera 2.

The camera 2 of the system 1 according to the invention is discussed below. The camera 2 has an objective lens 21, an infrared blocking filter 22 designed so as to be moveable and an optical sensor unit 23. In particular, the optical sensor unit 23 is designed as a semiconductor element, for example as a CMOS. The camera 2 furthermore has a communication module 24. The communication module 24 communicates with a communication module 31 of the processor unit 3, with a communication module 41 of the storage unit 4 and/or with a communication module 51 of the display unit 5, for example via a wireless connection, in particular a radio connection or a mobile radio connection. It is thereby possible to exchange data between at least two of the following units: the camera 2, the processor unit 3, the storage unit 4 and the display unit 5. The camera 2 also has a motion sensor 25 for detecting a movement, and a near-infrared light source 26.

The camera 2 is designed in particular as a wildlife camera and is used for example to record the object 7 in the form of a wild animal and/or in biological research to observe a wild animal. If the motion sensor 25 detects the presence of the object 7, for example in the form of the animal, an image of the object 7 is captured using the camera 2. More specifically, the objective lens 21 is used to image an image of the object 7 onto the optical sensor unit 23. By way of example, the image may be stored in the storage unit 4.

A computer program product is loaded in the processor unit 3 of the system 1 according to the invention. The computer program product contains a program code that, when it is executed in the processor unit 3, controls the system 1 according to the invention such that a method according to the invention is carried out.

FIG. 2 shows a flowchart of a first embodiment of the method according to the invention. In a method step S1, a first image is captured using the camera 2. The first image is illustrated schematically in FIG. 3 and is marked with the reference sign B1. The first image B1 contains a first set of first pixels P1ᵢⱼ, wherein i and j are integers for which: 1≤i≤n and 1≤j≤m, wherein n is the number of rows and m is the number of columns in the first image B1. The first image B1 is shown, by way of example, with only four rows and only four columns in FIG. 3 in order to explain the invention more easily. It is pointed out that the invention is not limited to a first image B1 containing only four rows and only four columns.

On the contrary, the first image B1 may contain any number of pixels, any number of rows and/or any number of columns suitable for the invention.

The first set of first pixels P1ᵢⱼ is in color. In other words, the first image B1 is a colored image composed of the first pixels P1ᵢⱼ. Provision is furthermore made for the first image B1 to show only the environment 6, 6A and 6B. In other words, the first image B1 is captured at a first time when the object 7 is not located in the field of view of the camera 2. In this respect, the first image B1 does not show the object 7, but rather only the environment 6, 6A and 6B in the field of view of the camera 2. By way of example, the first image B1 does not depict an animal, but rather only the animal's natural environment 6, 6A and 6B, for example a patch of forest located in the field of view of the objective lens 21 of the camera 2.

By way of example, the first image B1 is captured at a first time when there is sufficient natural brightness, in particular in daylight. The first image B1 is captured for example without the use of a flash of light. Provision is in particular made to capture the first image B1 with the infrared blocking filter 22 arranged in the beam path of the camera 2.

By way of example, the first image B1 is captured using the camera 2 such that each pixel of the first set of first pixels P1ᵢⱼ comprises color information and location information with regard to its position in the first image B1.

In a method step S2, a second image is captured using the camera 2, wherein the second image contains the environment 6, 6A and 6B, on the one hand, and an object 7 arranged in the environment 6, 6A and 6B, on the other hand. By way of example, the object 7 is an animal or comprises multiple animals. The second image is illustrated schematically in FIG. 4 and is marked with the reference sign B2. The second image B2 contains a second set of second pixels P2ᵢⱼ, wherein i and j are integers for which: 1≤i≤n and 1≤j≤m, wherein n is the number of rows and m is the number of columns in the second image B2.

The second image B2 contains a second set of second pixels P2ᵢⱼ, which are not in color. In other words, the second image B2 captured in method step S2 is not a colored image, but rather an image that depicts the environment 6, 6A and 6B, on the one hand, and the object 7 arranged in the environment 6, 6A and 6B, on the other hand, in grayscale levels (in extreme cases black or white).

By way of example, the second image B2 is captured without the infrared blocking filter 22 and using the near-infrared light source 26 that is arranged on the camera 2 and radiates the near-infrared light that it generates onto the object 7 and the environment 6, 6A and 6B located in the field of view of the camera 2. By way of example, the near-infrared light generally does not disturb an animal.

The second image B2 is captured in particular at a second time, different from the first time. By way of example, the first time is at a time of day when the first image B1 is able to be captured with natural brightness sufficient to be able to sufficiently recognize contours and details in the first image B1. By way of example, the first time is at a time of day when it is bright and the sun is generally shining. Furthermore, for example, the second time is at a time of day when it is not bright, in particular at night. The second time is for example a time when natural brightness is not sufficient to capture the second image B2 so as to be able to recognize contours and details of the environment 6, 6A and 6B and/or of the object 7 in the second image B2 (for example at dusk or at night). By way of example, the first time and the second time may be of the order of hours or days apart.

By way of example, the second image B2 is captured using the camera 2 such that each pixel of the second set of second pixels P2ᵢⱼ comprises information about a grayscale level and location information with regard to its position in the second image B2.

In a further method step S3 of the method according to the invention according to FIG. 2, a first subset of the set of second pixels P2ᵢⱼ of the second image B2 is determined using the processor unit 3. The first subset of the set of second pixels P2ᵢⱼ depicts the object 7. In other words, method step S3 comprises identifying those pixels from the set of the second pixels P2ᵢⱼ that contain only the object 7 (and not the environment 6, 6A and 6B) in the second image B2. These pixels then form the first subset of the set of second pixels P2ᵢⱼ. By way of example, the first subset of the set of second pixels P2ᵢⱼ is formed by the pixels P2₂₃, P2₂₄, P2₃₃ and P2₃₄.

Furthermore, in method step S3, a second subset of the set of second pixels P2ᵢⱼ of the second image B2 is determined using the processor unit 3. The second subset of the set of second pixels P2ᵢⱼ depicts the environment 6, 6A and 6B (and not the object 7). In other words, method step S3 comprises identifying those pixels from the set of the second pixels P2ᵢⱼ that contain only the environment 6, 6A and 6B (and not the object 7) in the second image B2. By way of example, the second subset of the set of second pixels P2ᵢⱼ is formed by the pixels P2₁₁, P2₁₂, P2₁₃, P2₁₄, P2₂₁, P2₂₂, P2₃₁, P2₃₂, P2₄₁, P2₄₂, P2₄₃, and P2₄₄.

In a further method step S4 of the method according to the invention according to FIG. 2, a subset of the set of first pixels P1ᵢⱼ of the first image B1 is determined using the processor unit 3. In other words, a few pixels are determined from the set of the first pixels P1ᵢⱼ of the first image B1 and form the abovementioned subset. Accordingly, the abovementioned subset comprises a smaller number of pixels than the set of the first pixels P1ᵢⱼ of the first image B1. The abovementioned subset comprises only pixels of the first image B1 that correspond to corresponding pixels of the set of second pixels P2ᵢⱼ of the second image B2, wherein the corresponding pixels of the set of second pixels P2ᵢⱼ of the second image B2 contain only the environment 6, 6A and 6B. In other words, the determined subset of the set of first pixels P1ᵢⱼ of the first image B1 comprises only pixels that show the environment 6, 6A and 6B, wherein this environment 6, 6A and 6B is also depicted by corresponding pixels of the set of second pixels P2ᵢⱼ of the second image B2. The determined subset of the set of first pixels P1ᵢⱼ of the first image B1 does not comprise any pixels at the position of which in the second image B2 the object 7 is depicted. The subset of the set of first pixels P1ᵢⱼ of the first image B1 may be determined in any way, and so it is possible to use any determination technique suitable for the invention. Provision is made in particular for the pixels of the abovementioned subset to be determined using a random generator. In addition or as an alternative thereto, provision is made for the pixels of the abovementioned subset to be distributed uniformly or non-uniformly in the first image B1. By way of example, the pixels P1₁₂, P1₁₄, P1₄₁ and P1₄₃ form the determined subset of first pixels P1ᵢⱼ of the first image B1. It is pointed out that the number of pixels of the determined subset of first pixels P1ᵢⱼ of the first image B1 is arbitrary, wherein the number is less than the total number of pixels P1ᵢⱼ of the set of first pixels P1ᵢⱼ of the first image B1.

In a further method step S5 of the method according to the invention according to FIG. 2, both the subset of the set of first pixels P1ᵢⱼ of the first image B1 (that is to say, in the embodiment illustrated here, the pixels P1₁₂, P1₁₄, P1₄₁ and P1₄₃) and the second subset of the set of second pixels P2ᵢⱼ of the second image B2 (that is to say, in the embodiment illustrated here, the pixels P2₁₁, P2₁₂, P2₁₃, P2₁₄, P2₂₁, P2₂₂, P2₃₁, P2₃₂, P2₄₁, P2₄₂, P2₄₃ and P2₄₄) are input into processor unit 3 as a first input variable E1, respectively as a second input variable E2. FIG. 5 shows a schematic illustration of the processor unit 3 into which the first input variable E1 and the second input variable E2 are input.

In a further method step S6 of the method according to the invention according to FIG. 2, color information is computed for at least one pixel of the second subset of the set of second pixels P2ᵢⱼ of the second image B2 (that is to say, in the embodiment illustrated here, the pixels P2₁₁, P2₁₂, P2₁₃, P2₁₄, P2₂₁, P2₂₂, P2₃₁, P2₃₂, P2₄₁, P2₄₂, P2₄₃ and P2₄₄) on the basis of at least one pixel of the subset of the set of first pixels P1ᵢⱼ of the first image B1 (that is to say, in the embodiment illustrated here, the pixels P1₁₂, P1₁₄, P1₄₁ and P1₄₃) using the processor unit 3. In other words, both the subset of the set of first pixels P1ᵢⱼ of the first image B1 (that is to say, in the embodiment illustrated here, the pixels P1₁₂, P1₁₄, P1₄₁ and P1₄₃) and the second subset of the set of second pixels P2ᵢⱼ of the second image B2 (that is to say, in the embodiment illustrated here, the pixels P2₁₁, P2₁₂, P2₁₃, P2₁₄, P2₂₁, P2₂₂, P2₃₁, P2₃₂, P2₄₁, P2₄₂, P2₄₃ and P2₄₄) are input into the processor unit 3 as input variables. The processor unit 3 then computes at least one output variable Ap, namely color information for at least one pixel of the second subset of the set of second pixels P2ᵢⱼ of the second image B2 (that is to say, in the embodiment illustrated here, the pixels P2₁₁, P2₁₂, P2₁₃, P2₁₄, P2₂₁, P2₂₂, P2₃₁, P2₃₂, P2₄₁, P2₄₂, P2₄₃ and P2₄₄) on the basis of at least one pixel of the subset of the set of first pixels P1ᵢⱼ of the first image B1 (that is to say, in the embodiment illustrated here, the pixels P1₁₂, P1₁₄, P1₄₁ and P1₄₃). By way of example, the processor unit 3 computes a respective output variable in the form of color information Ap for each pixel of the second subset of the set of second pixels P2ᵢⱼ of the second image B2 (that is to say, in the embodiment illustrated here, the pixels P2₁₁, P2₁₂, P2₁₃, P2₁₄, P2₂₁, P2₂₂, P2₃₁, P2₃₂, P2₄₁, P2₄₂, P2₄₃ and P2₄₄) on the basis of at least one pixel of the subset of the set of first pixels P1ᵢⱼ of the first image B1 (that is to say, in the embodiment illustrated here, the pixels P1₁₂, P1₁₄, P1₄₁ and P1₄₃), wherein: 1≤p≤o, wherein o is the number of pixels of the second subset of the set of second pixels P2ᵢⱼ of the second image B2. Provision is in particular made for the processor unit 3 to compute a respective output variable in the form of color information Ap for each pixel of the second subset of the set of second pixels P2ᵢⱼ of the second image B2 (that is to say, in the embodiment illustrated here, the pixels P2₁₁, P2₁₂, P2₁₃, P2₁₄, P2₂₁, P2₂₂, P2₃₁, P2₃₂, P2₄₁, P2₄₂, P2₄₃ and P2₄₄) on the basis of all pixels of the subset of the set of first pixels P1ᵢⱼ of the first image B1 (that is to say, in the embodiment illustrated here, the pixels P1₁₂, P1₁₄, P1₄₁ and P1₄₃), wherein: 1≤p≤o, wherein o is the number of pixels of the second subset of the set of second pixels P2ᵢⱼ of the second image B2.

The one or more pixels of the second subset of the set of second pixels of the second image thus receives/receive color information, even though these one or more pixels originally comprises/comprise only information with regard to a grayscale level.

The abovementioned computing is carried out for example using (i) a mathematical model, (ii) machine learning and/or (iii) an artificial neural network. In other words, for example, an artificial intelligence computes the one or more output variables Ap on the basis of the first input variable E1 and the second input variable E2. Using these one or more output variables, it is possible to generate the colored image. In addition or as an alternative thereto, provision is made for the abovementioned computing to be carried out using (i) a single mathematical model and/or (ii) a single artificial neural network. In other words, the processor unit 3 uses only a single mathematical model and/or only a single artificial neural network to compute the color information.

In a further method step S7 of the method according to the invention according to FIG. 2, the colored image that contains an object 7 arranged in the environment 6, 6A, 6B is generated on the basis of the second image B2 and on the basis of the color information of the at least one pixel of the second subset of the set of second pixels P2ᵢⱼ of the second image B2 (that is to say, in the embodiment illustrated here, the pixels P2₁₁, P2₁₂, P2₁₃, P2₁₄, P2₂₁, P2₂₂, P2₃₁, P2₃₂, P2₄₁, P2₄₂, P2₄₃ and P2₄₄) using the processor unit 3. In other words, the colored image is generated by way of the processor unit 3 based on the second image B2, which is not in color, on the one hand, and on the computed color information of the at least one pixel of the second subset of the set of second pixels P2ᵢⱼ of the second image B2, on the other hand (that is to say, in the embodiment illustrated here, the pixels P2₁₁, P2₁₂, P2₁₃, P2₁₄, P2₂₁, P2₂₂, P2₃₁, P2₃₂, P2₄₁, P2₄₂, P2₄₃ and P2₄₄), said colored image depicting the environment 6, 6A and 6B, on the one hand, and the object 7 arranged in the environment 6, 6A and 6B, on the other hand. By virtue of the method according to the invention, the environment 6, 6A and 6B in the generated colored image is depicted in color.

FIG. 6 shows a schematic illustration of the generated colored image B3. The colored image B3 contains a third set of third pixels P3ᵢⱼ, wherein i and j are integers for which: 1≤i≤n and 1≤j≤m, wherein n is the number of rows and m is the number of columns in the third image B3. The colored image B3 is shown, by way of example, with only four rows and only four columns in FIG. 6 in order to explain the invention more easily. It is pointed out that the invention is not limited to a colored image B3 containing only four rows and only four columns. On the contrary, the colored image B3 may contain any number of pixels, any number of rows and/or any number of columns suitable for the invention. In the embodiment illustrated here of the method according to the invention, no color information was computed for those pixels that depict the object 7. In this regard, in the colored image B3, the pixel P3₂₃ corresponds to the pixel P2₂₃, the pixel P3₂₄ corresponds to the pixel P2₂₄, the pixel P3₃₃ corresponds to the pixel P2₃₃ and the pixel P3₃₄ corresponds to the pixel P2₃₄. Accordingly, in this embodiment of the method according to the invention, only the environment 6, 6A and 6B is depicted in color. Conversely, the object 7 is depicted in grayscale.

In a further method step S8 of the method according to the invention according to FIG. 2, the colored image B3 is displayed (that is to say depicted) on the display unit 5. By way of example, the display unit 5 is a screen of a mobile communication unit, in particular of a portable telephone and/or of a tablet computer.

FIG. 7 shows a second embodiment of the method according to the invention. The embodiment according to FIG. 7 is based on the embodiment according to FIG. 2. Reference is therefore made to the explanations given above, which also apply here. In contrast to the embodiment of the method according to the invention according to FIG. 2, the embodiment of the method according to the invention according to FIG. 7 has two further method steps, which are carried out for example between method step S6 and method step S7. In the embodiment illustrated in FIG. 7 of the method according to the invention, provision is also made to depict the object 7 in color in the colored image B3. For this purpose, in method step S61, color information with regard to the object 7 for the first subset of the set of second pixels P2ᵢⱼ of the second image B2 is loaded from the storage unit 4 into the processor unit 3. As already mentioned above, the first subset of the set of second pixels P2ᵢⱼ depicts the object 7. These are the pixels from the set of the second pixels P2ᵢⱼ that contain only the object 7 (and not the environment 6, 6A and 6B) in the second image B2. By way of example, the first subset of the set of second pixels P2ᵢⱼ is formed by the pixels P2₂₃, P2₂₄, P2₃₃ and P2₃₄. In the embodiment illustrated in FIG. 7 of the method according to the invention, provision is then made, in method step S62, for color information to be computed for at least one pixel of the first subset of the set of second pixels P2ᵢⱼ of the second image B2 (in the embodiment illustrated here, these are the pixels P2₂₃, P2₂₄, P2₃₃ and P2₃₄) on the basis of the loaded color information using the processor unit 3. In other words, at least one pixel of the abovementioned first subset is assigned color information so that the object 7 is able to be depicted in color. Preferably, color information is computed for several of the pixels or for each of the pixels of the first subset of the set of second pixels P2ᵢⱼ of the second image B2 on the basis of the loaded color information using the processor unit 3. By way of example, the color information is computed such that both the pixels of the first subset of the set of second pixels P2ᵢⱼ of the second image B2 and the loaded color information are input into the processor unit 3 as input variables. The processor unit 3 then computes output variables, namely respective color information for at least (a) one pixel or (b) for multiple pixels or (c) for each pixel of the first subset of the set of second pixels P2ᵢⱼ of the second image B2 on the basis of the loaded color information. A pixel of the first subset of the set of second pixels P2ᵢⱼ of the second image B2 thus receives color information, even though this pixel originally comprises only information with regard to a grayscale level. By way of example, provision is made, in addition or as an alternative, for the abovementioned computing to be carried out using (i) a mathematical model, (ii) machine learning and/or (iii) an artificial neural network. In other words, for example, an artificial intelligence computes a very specific output variable, explained above or below, or multiple very specific output variables, explained above or below, on the basis of the predefined input variables, explained above or below. Using these one or more output variables, it is possible to generate the colored image. In addition or as an alternative thereto, provision is made for the abovementioned computing to be carried out using (i) a single mathematical model and/or (ii) a single artificial neural network. In other words, the processor unit 3 uses only a single mathematical model and/or only a single artificial neural network to compute the color information. In particular, provision is made, in this embodiment of the method according to the invention, for the colored image B3, which contains the environment 6, 6A and 6B, on the one hand, and the object 7 arranged in the environment 6, 6A and 6B, on the other hand, to be generated using the computed color information for the at least one pixel of the first subset of the set of second pixels P2ᵢⱼ of the second image B2. Preferably, the colored image B3 is generated using the computed color information for the multiple pixels or for each of the pixels of the first subset of the set of second pixels P2ᵢⱼ of the second image B2. The object 7 is then depicted in color in the generated colored image B3. FIG. 8 shows the colored image B3 thereby generated. FIG. 8 is based on FIG. 6. Identical parts are identified by identical reference signs. In contrast to the colored image B3 in FIG. 6, in the colored image B3 in FIG. 8, the pixels P3₂₃, P3₂₄, P3₃₃ and P3₃₄ depict the object 7 and comprise color information. In this respect, in addition to the environment 6, 6A and 6B, the object 7 is depicted in color in the colored image B3.

FIG. 9 shows a third embodiment of the method according to the invention. The embodiment according to FIG. 9 is based on the embodiment according to FIG. 2. Reference is therefore made to the explanations given above, which also apply here. In contrast to the embodiment of the method according to the invention according to FIG. 2, the embodiment of the method according to the invention according to FIG. 9 has two further method steps, which replace method step S1 and are carried out for example before method step S2. In the embodiment illustrated in FIG. 9 of the method according to the invention, provision is made, in method step S11, for the capturing of the first image B1 using the camera 2 to comprise not only capturing a single first image B1, but rather capturing multiple first images B1. Each image of the multiple first images B1 shows only the environment 6, 6A and 6B of the object 7, and therefore not the object 7 itself. In other words, each of the multiple first images B1 is captured at times when the object 7 is not located in the field of view of the camera 2. In this respect, each image of the multiple first images B1 does not show the object 7, but rather only the environment 6, 6A and 6B in the field of view of the camera 2. By way of example, each image of the multiple first images B1 does not depict an animal, but rather only the animal's natural environment, for example a patch of forest located in the field of view of the objective lens 21 of the camera 2. By way of example, the multiple first images B1 are captured when there is sufficient natural brightness. Reference is made to the explanations given above, which also apply here. Each image of the captured multiple images B1 is for example in the form as illustrated in FIG. 3. Reference is made to the explanations given above, which also apply here. In method step S12, the captured multiple images B1 are stored in the storage unit 4 after they have each been captured.

In the embodiment illustrated in FIG. 9 of the method according to the invention, a method step S31 takes place after method step S3, for example. In method step S31, one image of the captured multiple first images B1 is determined using the processor unit 3. This determined image is then used in method step S4 and the further method steps that follow method step S31. In particular, the subset of the set of first pixels P1ᵢⱼ of the first image B1 is determined such that a subset of the set of first pixels P1ᵢⱼ of the determined image of the multiple first images B1 is determined. By way of example, in this embodiment of the method according to the invention, provision is made for the determined image of the multiple first images B1 to be selected by a user or by the processor unit 3. In particular, the image of the multiple first images B1 that has the best contrast is selected. As an alternative, provision is made for example to combine two or more images of the multiple first images B1 with one another using the processor unit 3 such that in particular disturbances (for example shading, stray light or objects of no interest) are no longer visible or are barely still visible in the combined image. Provision is made in particular for the image of the multiple first images B1 to be determined such that the image is computed on the basis of the multiple first images B1 using the processor unit 3.

FIG. 10 shows a fourth embodiment of the method according to the invention. The embodiment according to FIG. 10 is based on the embodiment according to FIG. 2. Reference is therefore made to the explanations given above, which also apply here. In contrast to the embodiment of the method according to the invention according to FIG. 2, the embodiment of the method according to the invention according to FIG. 10 has a method step S21, which is carried out for example between method step S2 and method step S3. The camera 2 is generally designed to be stationary. The first image B1 and the second image B2 are therefore generally captured with the same field of view of the camera 2. However, due to external circumstances, it may be the case that the camera 2 moves slightly between the first time when the first image B1 is captured and the second time when the second image B2 is captured, such that the field of view of the camera 2 is slightly different at the first time and at the second time. In order to take this effect into account, in the embodiment illustrated in FIG. 10 of the method according to the invention, provision is made for the captured first image B1 and the captured second image B2 to be aligned with one another. In other words, each pixel of the first set of first pixels P1ᵢⱼ of the first image B1 is assigned to exactly one corresponding pixel of the second set of second pixels P2ᵢⱼ of the second image B2 using the processor unit 3. In yet other words, following the assignment, each pixel of the first image B1 corresponds to a corresponding pixel of the second image B2. By way of example, provision is made to ascertain a transformation function ϕ, such that the first pixels P1ᵢⱼ of the first image B1 correspond to the second pixels P2ᵢⱼ of the second image B2 (that is to say the first pixels P1ᵢⱼ of the first image B1 correspond to the second pixels P2ᵢⱼ of the second image B2). This is done for example by minimizing the following mathematical expression:

$${\sum }_{l ∈ \{ x , y \}} {‖ \vert {∇}_{l} Image 1 \vert - \vert {∇}_{l} Image 2 ( Φ ) \vert ‖}^{2} = {\sum }_{l ∈ \{ x , y \}} {‖ \vert {∇}_{l} Image 1 \vert ‖}^{2} - 2 \vert {∇}_{l} Image 1 \vert , \vert {∇}_{l} Image 2 ( Φ ) \vert + {‖ \vert {∇}_{l} Image 2 ( Φ ) \vert ‖}^{2}$$

where
Image1 and Image2 are each a monochromatic pixel image with the same resolution;
Image2(ϕ) denotes a pixel image with the same resolution, which was created by a local transformation ϕ of Image2;
∇ₓ and ∇_{y} are pixel-by-pixel directional derivatives of a monochromatic image;
   |∇ₗImage| is the respective pixel-by-pixel absolute value of a directional derivative;
∥A∥² denotes the sum of all squared pixel values of an image A; and
[symbol] (A, B) [symbol] is the vector scalar product of two images A and B considered as vectors.

Minimizing the above expression is equivalent to maximizing the expression [symbol] |∇ₗImage1|, |∇ₗImage2(ϕ)| [symbol] , that is to say the correlation of the two absolute gradients. In other words, Image2 is shifted such that its absolute gradients match those of Image1 as far as possible.

FIG. 11 shows a fifth embodiment of the method according to the invention. The embodiment according to FIG. 11 is based on the embodiment according to FIG. 2. Reference is therefore made to the explanations given above, which also apply here. In contrast to the embodiment of the method according to the invention according to FIG. 2, the embodiment of the method according to the invention according to FIG. 11 has two further method steps, which are carried out for example between method step S3 and method step S4. The embodiment illustrated in FIG. 11 of the method according to the invention takes into account the effect that certain details of the environment 6, 6A and 6B depicted in the second image B2 are not particularly clearly visible. This is due for example to the fact that the second image B2 is captured when there is not sufficient brightness, in particular at night. In order to counteract this effect, in this embodiment of the method according to the invention, provision is made for the second image B2 to be processed before the second subset of the set of second pixels P2ᵢⱼ of the second image B2 is input into the processor unit 3 as an input variable. If for example a pixel of the second subset of the set of second pixels P2ᵢⱼ of the second image B2 does not satisfy a predefinable quality criterion, this pixel is selected using the processor unit 3 in method step S32. The selected pixel is then, in method step S33, blended with a corresponding pixel of the first set of first pixels P1ᵢⱼ of the first image B1 using the processor unit 3. In other words, the selected pixel of the second subset of the set of second pixels P2ᵢⱼ of the second image B2 (that is to say a pixel that concerns only the environment 6, 6A and 6B) is enriched with information about the brightness of a pixel, corresponding to the selected pixel, of the first set of first pixels P1ᵢⱼ of the first image B1 (wherein the corresponding pixel also likewise concerns only the environment 6, 6A and 6B). By way of example, the blending is carried out by replacement. In other words, in the second image B2, a pixel that concerns only the environment 6, 6A and 6B is replaced by a pixel, corresponding to this pixel, of the first image B1 (wherein the corresponding pixel likewise concerns only the environment 6, 6A and 6B) if the pixel in the second image B2 does not satisfy the predefinable quality criterion. As an alternative thereto, provision is made for example for the blending to be produced by alpha blending. In alpha blending, the selected pixel of the second subset of the set of second pixels P2ᵢⱼ of the second image B2 is assigned mixed information on the basis of the brightness of the selected pixel and of the pixel, corresponding to the selected pixel, of the first set of first pixels P1ᵢⱼ of the first image B1. By way of example, the predefinable quality criterion or a weighting of the alpha blending depends on the contrast.

In all embodiments of the method according to the invention, it is ensured that the colored image B3 is generated based on the second image B2 containing grayscale levels. In contrast to the known prior art, a subset of the set of first pixels P1ᵢⱼ of the first image B1 is used here, wherein the pixels of this subset contain color information. This color information is used to compute color information for at least one pixel of the second, non-colored image B2 in order ultimately to generate the colored image B3 that contains a color environment 6, 6A and 6B and an object 7 arranged in the environment 6, 6A and 6B.

FIG. 12 shows a further embodiment of a system 1 according to the invention for generating a colored image that contains an object 7 arranged in an environment 6, 6A and 6B. The further embodiment according to FIG. 12 is based on the embodiment according to FIG. 1. Identical components are provided with identical reference signs. Reference is therefore made to the explanations given above, which also apply here. In contrast to the embodiment according to FIG. 1, the camera 2 of the further embodiment according to FIG. 12 has a first camera unit 60A and a second camera unit 60B. However, the invention is not limited to two camera units. On the contrary, any number of camera units suitable for the invention may be used. The first camera unit 60A has a first objective lens 21A. The second camera unit 60B has a second objective lens 21B. By way of example, the first camera unit 60A and the second camera unit 60B are arranged in relation to one another such that the axes of the objective lenses 21A, 21B of the camera units 60A, 60B are oriented parallel to one another.

By way of example, in the further system 1 according to the invention according to FIG. 12, the first image B1 is captured using the first camera unit 60A. As already mentioned above, the first image B1 contains the first set of first pixels, which are in color. By way of example, the first image B1 is captured when there is sufficient natural brightness, in particular in daylight. The first image B1 shows the environment 6, 6A and 6B. The first image B1 is accordingly captured for example without the use of a flash of light. The captured first image B1 is a colored image. In other words, the captured first image B1 is in color. The second image B2 is captured, in the system 1 according to the invention according to FIG. 12, for example using the second camera unit 60B, wherein the second image B2 contains the environment 6, 6A and 6B, on the one hand, and the object 7 arranged in the environment 6, 6A and 6B, on the other hand. By way of example, the object 7 is an animal or comprises multiple animals. As already mentioned above, the second image B2 contains the second set of second pixels, which are not in color. In other words, the captured second image B2 is not a colored image, but rather an image that depicts the environment 6, 6A and 6B, on the one hand, and the object 7 arranged in the environment 6, 6A and 6B, on the other hand, in grayscale levels (in extreme cases black or white). By way of example, the second image B2 is captured using the near-infrared light source 26 that is arranged on the camera 2 and radiates the near-infrared light that it generates onto the object 7 and the environment located in the field of view of the second camera unit 60B. By way of example, the near-infrared light generally does not disturb an animal. The second image B2 is captured in particular at a time when natural brightness is not sufficient to capture the second image B2 so as to be able to recognize contours and details of the environment 6, 6A and 6B and/or of the object 7 in the second image B2 (for example at dusk or at night). However, as explained above, the second image B2 is not a colored image, but rather an image that depicts the object 7 depicted in the second image B2 and its environment 6, 6A and 6B in grayscale levels (in extreme cases black or white). With regard to all further method steps, reference is made to the explanations given above, which also apply here, in particular the explanations in relation to FIGS. 2 to 11.

In the further embodiment of the system 1 according to the invention according to FIG. 12, provision is made for example for the first set of the first pixels of the first image B1 to be scaled to the second set of the second pixels of the second image B2, for example using the processor unit 3. In addition or as an alternative thereto, provision is made for the second set of the second pixels of the second image B2 to be scaled to the first set of the first pixels of the first image B1, for example using the processor unit 3.

All of the embodiments above and below of the method according to the invention are not restricted to the mentioned sequence of the method steps. The invention also comprises different sequences of the method steps that are suitable for solving the problem within the meaning of the invention. As an alternative or in addition, in the method according to the invention, provision is also made to carry out at least two method steps in parallel. Moreover, the embodiments above and below of the method according to the invention are not restricted to the complete scope of all of the method steps mentioned above or below. In particular, provision is made for individual or a plurality of the method steps above or below to be omitted in further embodiments.

The features of the invention that are disclosed in the present description, in the drawings and in the claims may be essential for the implementation of the invention in its various embodiments both individually and in any desired combinations. The invention is not restricted to the described embodiments. It may be varied within the scope of the claims and taking into account the knowledge of those skilled in the relevant art.

### LIST OF REFERENCE SIGNS

1 System
2 Camera
3 Processor unit
4 Storage unit
5 Display unit
6 Environment
6A Environment
6B Environment
7 Object
21 objective lens
21A First objective lens
21B Second objective lens
22 Infrared blocking filter
23 Sensor unit
24 Communication module
25 Motion sensor
26 Near-infrared light source
31 Communication module
41 Communication module
51 Communication module
60A First camera unit
60B Second camera unit
A₁ to A₀ Output variable
E1 First input variable
E2 Second input variable
B1 First image
B2 Second image
B3 Colored image
P1₁₁ Pixel in the first image
P1₁₂ Pixel in the first image
P1₁₃ Pixel in the first image
P1₁₄ Pixel in the first image
P1₂₁ Pixel in the first image
P1₂₂ Pixel in the first image
P1₂₃ Pixel in the first image
P1₂₄ Pixel in the first image
P1₃₁ Pixel in the first image
P1₃₂ Pixel in the first image
P1₃₃ Pixel in the first image
P1₃₄ Pixel in the first image
P1₄₁ Pixel in the first image
P1₄₂ Pixel in the first image
P1₄₃ Pixel in the first image
P1₄₄ Pixel in the first image
P2₁₁ Pixel in the second image
P2₁₂ Pixel in the second image
P2₁₃ Pixel in the second image
P2₁₄ Pixel in the second image
P2₂₁ Pixel in the second image
P2₂₂ Pixel in the second image
P2₂₃ Pixel in the second image
P2₂₄ Pixel in the second image
P2₃₁ Pixel in the second image
P2₃₂ Pixel in the second image
P2₃₃ Pixel in the second image
P2₃₄ Pixel in the second image
P2₄₁ Pixel in the second image
P2₄₂ Pixel in the second image
P2₄₃ Pixel in the second image
P2₄₄ Pixel in the second image
P3₁₁ Pixel in the colored image
P3₁₂ Pixel in the colored image
P3₁₃ Pixel in the colored image
P3₁₄ Pixel in the colored image
P3₂₁ Pixel in the colored image
P3₂₂ Pixel in the colored image
P3₂₃ Pixel in the colored image
P3₂₄ Pixel in the colored image
P3₃₁ Pixel in the colored image
P3₃₂ Pixel in the colored image
P3₃₃ Pixel in the colored image
P3₃₄ Pixel in the colored image
P3₄₁ Pixel in the colored image
P3₄₂ Pixel in the colored image
P3₄₃ Pixel in the colored image
P3₄₄ Pixel in the colored image
S1 to S8 Method steps
S11 Method step
S12 Method step
S21 Method step
S31 Method step
S32 Method step
S33 Method step
S61 Method step
S62 Method step

1. A method for generating a colored image that contains an object arranged in an environment, comprising the following method steps:
capturing a first image using a camera, wherein the first image contains a first set of first pixels, which are in color, and wherein the first image shows only the environment;
capturing a second image using the camera, wherein the second image contains a second set of second pixels, which are not in color, and wherein the second image contains the environment, on the one hand, and an object arranged in the environment, on the other hand;
determining a first subset of the set of second pixels of the second image using a processor unit, wherein the first subset of the set of second pixels depicts the object, and determining a second subset of the set of second pixels of the second image-using the processor unit, wherein the second subset of the set of second pixels depicts the environment;
determining a subset of the set of first pixels of the first image using the processor unit, wherein the subset comprises only pixels of the first image that correspond to corresponding pixels of the set of second pixels of the second image, wherein the corresponding pixels of the set of second pixels of the second image contain only the environment;
inputting both the subset of the set of first pixels of the first image and the second subset of the set of second pixels of the second image into the processor unit as input variables;
computing color information for at least one pixel of the second subset of the set of second pixels of the second image on the basis of at least one pixel of the subset of the set of first pixels of the first image using the processor unit; and
generating the colored image that contains an object arranged in the environment on the basis of the second image and on the basis of the computed color information of the at least one pixel of the second subset of the set of second pixels of the second image using the processor unit.

2. The method as claimed in claim 1, wherein
the first image is captured at a first time using the camera, and wherein
the second image is captured at a second time, different from the first time, using the camera.

3. The method as claimed in claim 1, wherein
the first image is captured using the camera such that each pixel of the first set of first pixels comprises color information and location information with regard to its position in the first image; and/or wherein
the second image is captured using the camera such that each pixel of the second set of second pixels comprises grayscale information and location information with regard to its position in the second image.

4. The method as claimed in claim 1, wherein the computing is carried out such that color information is computed for each pixel of the second subset of the set of second pixels of the second image using the processor unit.

5. The method as claimed in claim 1, wherein the computing is carried out on the basis of the subset of the set of first pixels of the first image.

6. The method as claimed in claim 1, wherein the method comprises the following method steps:
loading color information with regard to the object for the first subset of the set of second pixels of the second image from a storage unit into the processor unit; and
computing color information for at least one pixel of the first subset of the set of second pixels of the second image on the basis of the loaded color information using the processor unit, wherein the colored image that contains the object arranged in the environment is generated using the color information for the at least one pixel of the first subset of the set of second pixels of the second image.

7. The method as claimed in claim 6, wherein the computing is carried out on the basis of the loaded color information using the processor unit such that the color information is computed for each pixel of the first subset of the set of second pixels of the second image, wherein the colored image that contains the object arranged in the environment is generated using the color information for each pixel of the first subset of the set of second pixels of the second image.

8. The method as claimed in claim 1, wherein the method comprises one of the following method steps:
a) the computing is carried out (i) using a mathematical model, (ii) using machine learning and/or (iii) using an artificial neural network;
b) the computing is carried out (i) using a single mathematical model and/or (ii) using a single artificial neural network.

9. The method as claimed in claim 1, wherein the generated colored image that contains the object arranged in the environment is displayed on a display unit.

10. The method as claimed in claim 1, wherein the method comprises the following method steps:
capturing the first image using the camera comprises capturing multiple first images, wherein each image of the multiple first images shows only the environment and wherein each image of the multiple first images contains a first set of first pixels, which are in color; and
determining one image of the multiple first images using the processor unit, wherein the subset of the set of first pixels is determined such that a subset of the set of first pixels of the determined image of the multiple first images is determined.

11. The method as claimed in claim 10, wherein the image of the multiple first images is determined such that the image is computed using at least two images of the multiple first images using the processor unit.

12. The method as claimed in claim 1, wherein each pixel of the first set of first pixels of the first image is assigned exactly one corresponding pixel of the second set of second pixels of the second image-using the processor unit.

13. The method as claimed in claim 1, wherein the method comprises the following method steps before the second subset of the set of second pixels of the second image is input into the processor unit as an input variable:
if a pixel of the second subset of the set of second pixels of the second image-does not satisfy a predefinable quality criterion, selecting this pixel of the second subset of the set of second pixels of the second image using the processor unit; and
blending the selected pixel of the second subset of the set of second pixels of the second image with a corresponding pixel of the first set of first pixels of the first image using the processor unit.

14. The method as claimed in claim 1, wherein, after the first image has been captured using the camera, the first image is stored in an image storage unit and is loaded into the processor unit in order to determine the subset of the set of first pixels of the first image.

15. A computer program product containing a program code that is able to be loaded into a processor unit of a system for generating a colored image that contains an object arranged in an environment and, when it is executed, controls the system such that a method as claimed in at least one of the preceding claims is carried out.

16. A system for generating a colored image that contains an object arranged in an environment, comprising
a camera for capturing images, and comprising
a processor unit into which a computer program product as claimed in claim 15 is loaded.

17. The system as claimed in claim 16, wherein the system has at least one of the following features:
a storage unit; and
a display unit.
